(19) United States
(12) Patent Application Publication
(10) Pub. No.: US 2010/0328847 A1
(43) Pub. Date: Dec. 30, 2010

(54) SOLID ELECTROLYTIC CAPACITOR AND METHOD FOR MANUFACTURING THE SAME

(75) Inventors: Takashi Umemoto, Hirakata-city (JP); Masaaki Nemoto, Hirakata-city (JP); Hiroshi Nonoue, Hirakata-city (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi-city (JP)

(21) Appl. No.: 12/866,926

(22) PCT Filed: Feb. 17, 2009
(86) PCT No.: PCT/JP2009/000624

§ 371 Date: Aug. 10, 2010

(30) Foreign Application Priority Data
Feb. 21, 2008 (JP) 2008-039997

(51) Int. Cl. H01G 9/08; H01G 9/15; H01G 9/025; B05D 5/12

(52) U.S. Cl. 361/525; 361/535; 361/534; 427/80

(57) ABSTRACT

To reduce the increase in leakage current in a molding process. A solid electrolytic capacitor includes: an anode 3 formed from a valve metal or an alloy thereof; an anode lead 2 partly embedded in the anode 3; a dielectric layer 4 provided on the surface of the anode 3; an electrolyte layer 5 provided on the surface of the dielectric layer 4; a cathode layer 6 provided on a part of the electrolyte layer 5 lying on the external surface of the anode 3; and a resin outer package 8 formed to cover a capacitor element formed of the anode 3 in which a part of the anode lead 2 is embedded and on which the dielectric layer 4, the electrolyte layer 5 and the cathode layer 6 are formed, wherein the solid electrolytic capacitor further includes: a first resin layer 10 provided to cover parts of the dielectric layer 4 and the electrolyte layer 5 located at the root 2a of an extension of the anode lead 2 and on a neighboring part of the extension; and a second resin layer 11 provided to cover the first resin layer 10, and the second resin layer 11 is formed from a resin having a smaller flexural modulus than a resin forming the first resin layer 10.

### TECHNICAL FIELD

This invention relates to solid electrolytic capacitors and methods for manufacturing the same.

### BACKGROUND ART

Solid electrolytic capacitors are conventionally known in which an anode made of a valve metal is anodized in an aqueous solution of phosphoric acid to form a dielectric layer made of an oxide of the metal on the surface of the anode and an electrolyte layer made of manganese dioxide is further formed on the dielectric layer.

Such a solid electrolytic capacitor having an electrolyte layer made of manganese dioxide formed therein, however, has the problem of increased equivalent series resistance (ESR) because the electric conductivity of manganese dioxide is small as compared to those of metals.

Meanwhile, solid electrolytic capacitors are known which are aimed at reducing the ESR by using a conductive polymer instead of manganese dioxide as an electrolyte layer.

However, such a solid electrolytic capacitor using a conductive polymer as an electrolyte layer has the problem of increased leakage current as compared to solid electrolytic capacitors using manganese dioxide as their electrolyte layers. Particularly, a solid electrolytic capacitor of such kind using niobium for the anode has the problem of increased leakage current in a molding process for forming a resin outer package for covering a capacitor element because its oxide layer serving as a dielectric layer is susceptible to heat and also sensitive to stress.

Patent Document 1 discloses that a filler-containing epoxy resin layer is formed to cover a part of a conductive polymer layer exposed from a cathode layer at the top surface of a capacitor element and its neighboring part. The document describes that therefore the inversion of oxygen into the conductive polymer layer from the outside can be prevented to suppress the degradation of the conductive polymer due to oxygen and thereby reduce the increase in ESR.

However, the above document does not disclose any means for reducing the increase in leakage current in a molding process at all.

Patent Document 2 discloses that an anti-liquid rise part is provided around an anode lead, a conductive polymer layer is then formed and a first resin-coated part is formed to cover the anti-liquid rise part. The document further discloses that a side of the conductive polymer layer of the capacitor element at which the anode lead is formed is covered with a second resin-coated part. The document describes that therefore the mechanical strength can be increased to improve the leakage current characteristic.

However, the above document does not disclose any problem of increased leakage current in a molding process and any means for reducing the increase in leakage current in the molding process.

Patent Document 1: Published Japanese Patent Application No. H09-45591

### Patent Document 2: Published Japanese Patent Application No. 2001-185456

### DISCLOSURE OF THE INVENTION

An object of the present invention is to provide a solid electrolytic capacitor that can reduce the increase in leakage current in a molding process and a method for manufacturing the same.

The present invention is directed to a solid electrolytic capacitor including: an anode made of a valve metal or an alloy thereof; an anode lead partly embedded in the anode; a dielectric layer provided on the surface of the anode; an electrolyte layer provided on the surface of the dielectric layer; a cathode layer provided on a part of the electrolyte layer lying on the external surface of the anode; and a resin outer package formed to cover a capacitor element comprising the anode in which a part of the anode lead is embedded, the dielectric layer, the electrolyte layer and the cathode layer, wherein the solid electrolytic capacitor further includes: a first resin layer provided to cover the root of an extension of the anode lead extended from the anode, in which the anode lead is embedded, and cover parts of the dielectric layer and the electrolyte layer located on a neighboring part of the extension; and a second resin layer provided to cover the first resin layer, and the second resin layer is formed from a resin having a smaller flexural modulus than a resin forming the first resin layer.

In the present invention, a first resin layer is provided to cover parts of the dielectric layer and the electrolyte layer located at the root of an extension of the anode lead extended from the anode in which the anode lead is embedded and on a neighboring part of the extension. Thus, the stress applied through the anode lead to the interior of the capacitor element in the molding process can be reduced. Furthermore, in the present invention, a second resin layer is provided to cover the first resin layer, and the second resin layer is formed from a resin having a smaller flexural modulus than a resin forming the first resin layer. By providing such a second resin, the stress applied to the capacitor element when a resin is poured in the molding process can be effectively reduced. Therefore, according to the present invention, the increase in leakage current in the molding process can be reduced.

In the present invention, the second resin layer may be provided to cover the entire surface of the first resin layer. If the second resin layer is provided to cover the entire surface of the first resin layer, the stress reduction effect of the first and second resin layers can be more pronounced, which further reduces the increase in leakage current in the molding process.

In the present invention, the flexural modulus of the resin forming the second resin layer is preferably smaller than that of a material forming the electrolyte layer covered by the second resin layer.

Thus, the stress applied to the electrolyte layer can be more effectively relieved, which further reduces the increase in leakage current in the molding process.

In the present invention, the Shore hardness of the resin forming the second resin layer is preferably smaller than that of the material forming the electrolyte layer covered by the second resin layer.

Thus, the stress applied to the electrolyte layer can be more effectively relieved, which further reduces the increase in leakage current in the molding process.

In the present invention, it is preferable that the Shore hardness of the resin forming the first resin layer is not less than 80 and is greater than that of the resin forming the second resin layer. Thus, the stress applied through the anode lead to the interior of the capacitor element in the molding process can be reduced, and the stress applied to the capacitor element during resin pouring can be reduced, whereby the increase in leakage current can be further reduced.

In the present invention, it is preferable that the Shore hardness of the resin forming the second resin layer is not more than 50 and is smaller than that of the resin forming the first resin layer. Thus, the stress applied through the anode lead to the interior of the capacitor element in the molding process can be reduced, and the stress applied to the capacitor element during resin pouring can be reduced, whereby the increase in leakage current can be further reduced.

The first resin layer in the present invention can be formed, for example, from an epoxy resin. The second resin layer in the present invention can be formed, for example, from a silicone resin or an urethane resin.

The electrolyte layer in the present invention is preferably formed from a conductive polymer. By forming the electrolyte layer from a conductive polymer, the ESR can be reduced. Particularly if the electrolyte layer is formed from a conductive polymer as described above, this might present the problem of increased leakage current. According to the present invention, the increase in leakage current in the molding process can be reduced. Therefore, through the application of the present invention, the above problem can be eliminated which might otherwise arise where the electrolyte layer is formed from a conductive polymer.

A manufacturing method of the present invention is a method capable of manufacturing the above solid electrolytic capacitor of the present invention and includes the steps of: forming the anode in which a part of the anode lead is embedded; forming the dielectric layer on the surface of the anode; forming the electrolyte layer on the surface of the dielectric layer; forming the cathode layer on the electrolyte layer; forming the first resin layer by application to cover parts of the dielectric layer and the electrolyte layer located at the root of the extension of the anode lead extended from the anode in which the anode lead is embedded and on the neighboring part of the extension; forming the second resin layer by application to cover the first resin layer; and forming the resin outer package to cover the capacitor element.

According to the manufacturing method of the present invention, since the first and second resin layers are provided at a location where stress can be applied in a molding process, the stress applied to the capacitor element in the molding process can be reduced, whereby a solid electrolytic capacitor can be manufactured to reduce the increase in leakage current.

### EFFECTS OF THE INVENTION

According to the present invention, the increase in leakage current in the molding process can be reduced.

Furthermore, according to the manufacturing method of the present invention, a solid electrolytic capacitor can be manufactured to reduce the increase in leakage current in the molding process.

### BRIEF DESCRIPTION OF THE DRAWINGS

FIG. 1 is a schematic cross-sectional view showing a solid electrolytic capacitor of Example 1 according to the present invention.

FIG. 2 is a schematic cross-sectional view showing a solid electrolytic capacitor of Example 2 according to the present invention.

FIG. 3 is a schematic cross-sectional view showing a solid electrolytic capacitor of Comparative Example 1.

### LIST OF REFERENCE NUMERALS

1 . . . anode lead frame
2 . . . anode lead
2a . . . extension root of anode lead
3 . . . anode
4 . . . dielectric layer
5 . . . electrolyte layer
6 . . . cathode layer
6a . . . carbon layer
6b . . . silver paste layer
7 . . . cathode lead frame
8 . . . resin outer package
9 . . . conductive adhesive layer
10 . . . first resin layer
11 . . . second resin layer

### BEST MODE FOR CARRYING OUT THE INVENTION

Hereinafter, the present invention will be more specifically described with reference to examples. However, the present invention is not limited by the following examples and can be implemented by appropriately modifying them within the scope not changing the gist of the invention.

### Experiment 1

### Example 1

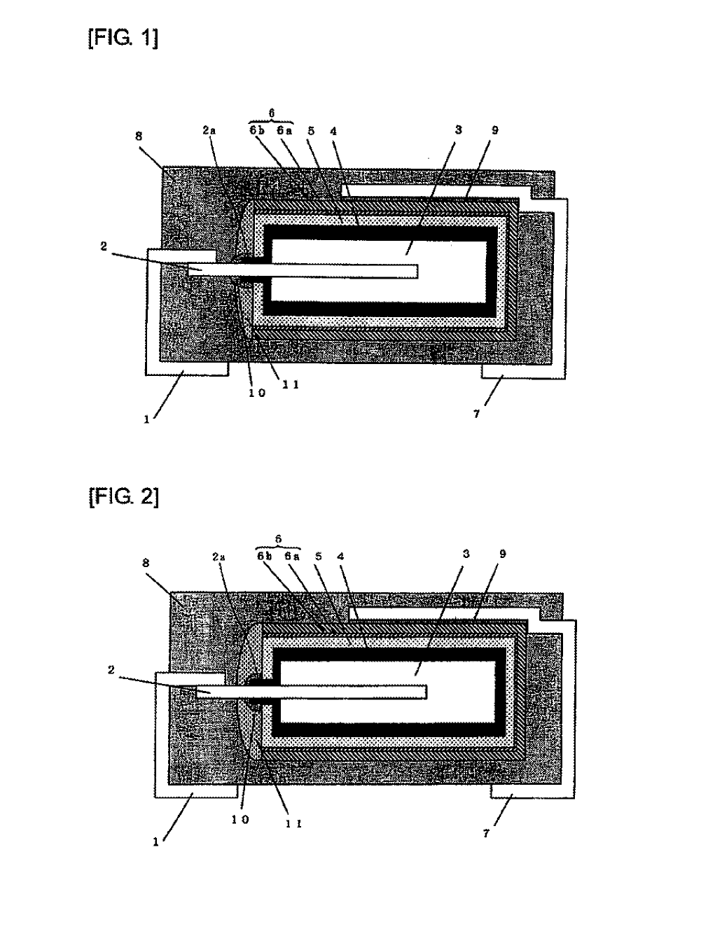

FIG. 1 is a schematic cross-sectional view showing a solid electrolytic capacitor of Example 1 according to the present invention.

As shown in FIG. 1, a part of an anode lead 2 is embedded in an anode 3. The anode 3 in which a part of the anode lead 2 is embedded can be produced by forming powder of a valve metal into a green body with a part of the anode lead 2 embedded therein and sintering the formed body in a vacuum.

The anode 3 can be formed from a material containing a valve metal or an alloy thereof. Examples of the valve metal include niobium, tantalum, titanium and aluminum. Examples of the alloy containing a valve metal as a main ingredient include alloys containing the above metals as their main ingredients. The anode may be formed from an oxide of such a metal, such as niobium monoxide. In the present invention, the anode is preferably formed from niobium, an alloy containing niobium as a main ingredient or niobium monoxide.

A dielectric layer 4 made of an oxide is formed on the surface of the anode 3 and a part of the surface of the anode lead 2. The anode 3 is a porous body, and the dielectric layer 4 is therefore formed also on the inside surfaces of the anode 3. The dielectric layer 4 is formed by anodizing the anode 3.

An electrolyte layer 5 is formed on the dielectric layer 4. The electrolyte layer 5 is formed also on the part of the dielectric layer 4 located inside the anode 3. The electrolyte layer 5 can be formed from a conductive metal oxide, such as manganese dioxide, or a conductive polymer. To increase the ESR, the electrolyte layer 5 is preferably formed from a conductive polymer. Examples of the conductive polymer that can be used include polyethylenedioxythiophene, polypyrrole, and polyaniline. Examples of a method for forming a conductive polymer layer include chemical polymerization and electropolymerization. In this example, a conductive polymer layer made of polypyrrole is formed as the electrolyte layer 5.

A carbon layer 6a and a silver paste layer 6b are formed on a part of the electrolyte layer 5 lying on the external surface of the anode 3. The carbon layer 6a is formed by applying a carbon paste. The silver paste layer 6b is formed by applying a silver paste. A cathode layer 6 is constituted by the carbon layer 6a and the silver paste layer 6b.

As shown in FIG. 1, the cathode layer 6 is not formed on the side surface of the anode 3 at which the anode lead 2 is embedded, and the electrolyte layer 5 is exposed at the side surface. Furthermore, at the embedded part 2a of the anode lead 2, the dielectric layer 4 is formed also on the anode lead 2.

As shown in FIG. 1, in this example, a first resin layer 10 is provided to cover the root 2a of an extension (hereinafter, referred to as “extension root”) of the anode lead 2 extended from the anode 3 in which the anode lead 2 is embedded, and a neighboring part of the extension. The first resin layer 10 is formed to partly cover the exposed part of the electrolyte layer 5.

Furthermore, in this example, a second resin layer 11 is provided to cover the first resin layer 10. The second resin layer 11 is formed to cover not only the first resin layer 10 but also a part of the electrolyte layer 5 which lies on the above side surface of the anode 3 and is not covered with the first resin layer 10.

The first resin layer 10 and the second resin layer 11 can be formed, for example, from epoxy resin, silicone resin, urethane resin or fluorine-contained resin, and a liquid resin composition containing a filler, such as silica or alumina, is preferably used for the resin layers. The first resin layer 10 and the second resin layer 11 can be formed, for example, by applying a liquid resin composition containing such a filler and then drying it by heat application. These resin layers are preferably formed from thermosetting resin compositions. In this example, as described hereinafter, the first resin layer 10 is formed from an epoxy resin composition containing a silica filler, and the second resin layer 11 is formed from a silicone resin containing a silica filler.

The cathode layer 6 is connected through a conductive adhesive layer 9 to a cathode lead frame 7. On the other hand, the anode lead 2 is connected to an anode lead frame 1 by welding. A solid electrolytic capacitor is formed by covering the entire capacitor element with a resin outer package 8 made of an epoxy resin composition to expose the ends of both the anode lead frame 1 and the cathode lead frame 7 from the resin outer package B.

In this example, as described above, the first resin layer 10 is provided to cover parts of the dielectric layer 4 and electrolyte layer 5 located at the extension root 2a of the anode lead 2 and on its neighboring part, and the second resin layer 11 is provided to cover this first resin layer 10. Furthermore, the second resin layer 11 is formed from a resin having a smaller flexural modulus than the resin forming the first resin layer 10. Therefore, during the formation of a resin outer package 8 in a molding process, the stress applied to the extension root 2a of the anode lead 2 can be effectively relieved, whereby the increase in leakage current induced by the stress can be reduced. Since the first resin layer 10 is formed from a resin having a greater flexural modulus than the second resin layer 11, the stress applied to the anode lead in the molding process can be relieved by the second resin layer 11 having a smaller flexural modulus, and the stress transmitted through the anode lead to the capacitor element interior can be relieved by the first resin layer 10 having a greater flexural modulus. Therefore, the stress can be more effectively relieved.

A solid electrolytic capacitor of this example was produced according to the following Step 1 to Step 6.

[Step 1]

Niobium metal powder having an average primary particle diameter of approximately 0.5 μm was used and formed into a green body with a part of an anode lead terminal embedded therein. The green body was sintered in a vacuum to form an anode 3 consisting of a porous sintered niobium body with a height of approximately 4.4 mm, a width of approximately 3.3 mm and a depth of approximately 1.0 mm.

[Step 2]

The anode 3 was anodized at a constant voltage of approximately 10 V for approximately ten pours in an approximately 0.1% by weight aqueous solution of ammonium fluoride held at approximately 40° C. Then, the anode 3 was anodized at a constant voltage of approximately 10 V for approximately two hours in an approximately 0.5% by weight aqueous solution of phosphoric acid held at approximately 60° C. Thus, a dielectric layer 4 containing fluorine was formed on the anode 3 and a part of the surface of the anode lead 2.

[Step 3]

An electrolyte layer 5 made of polypyrrole was formed on the surface of the dielectric layer 4 by chemical polymerization or other methods. Next, a carbon layer 6a was formed on a part of the electrolyte layer 5 lying on the external surface of the anode 3 by applying a carbon paste thereon and drying it. A silver paste layer 6b was formed on the carbon layer 6a by applying a silver paste thereon and drying it. A cathode layer 6 composed of these carbon layer 6a and silver paste layer 6b was not formed on one of the side surfaces of the anode 3, as shown in FIG. 1. Therefore, the electrolyte layer 5 was exposed at the one side surface of the anode 3.

A cathode lead frame 7 was connected through a conductive adhesive layer 9 to the cathode layer 6. On the other hand, an anode lead frame 1 was connected to the anode lead 2.

The flexural modulus of the polypyrrole-made conductive polymer forming the electrolyte layer 5 was 6000 MPa, and the Shore hardness D thereof was 90.

[Step 4]

A first resin layer 10 was formed by applying an epoxy resin to the extension root 2a of the anode lead 2 of the capacitor element produced in Step 3 and its neighboring part and subjecting it to heat application at 100° C. for 30 minutes after the resin application. The epoxy resin used had the following composition.

Phenol novolak type epoxy resin: 100 parts by weight,

Spherical silica: 100 parts by weight, and

Methyltetrahydrophthalic acid anhydride: 1 part by weight.

The flexural modulus of the hardened material of the epoxy resin used was 5000 MPa, and the Shore hardness D thereof was 90.

[Step 5]

As shown in FIG. 1, a second resin layer 11 was formed to cover the surface of the first resin layer 10 formed in Step 4. The second resin layer 11 was formed by applying a silicone resin having a composition indicated below and subjecting it to heat application at 100° C. for 30 minutes after the resin application.

Polyalkylalkenylsiloxane: 100 parts by weight,

Spherical silica: 30 parts by weight, and

Organohydrogenpolysiloxane: 10 parts by weight.

The flexural modulus of the hardened material of the silicone resin used was 1000 MPa, and the Shore hardness D thereof was 20.

[Step 6]

A resin outer package 8 was formed around the capacitor element obtained in Step 5 by transfer molding using a sealant containing an epoxy resin, a filler and an imidazole compound. Specifically, the sealant previously heated at 160° C. was poured into a mold under a pressure of 80 kg/cm², and the resin was cured by heating it in the mold under conditions of 160° C. for 90 seconds.

[Method for Measuring Flexural Modulus]

The resin was cured by heat application at 100° C. for 30 minutes to form it into a board shape having a thickness of 4 mm. A test specimen of 10 mm width and 80 mm length was cut out of the above board-shaped form. The test specimen was used to perform a three-point bending test according to JIS-K6911, and its flexural modulus was obtained from the resulting load-deflection curve.

[Method for Measuring Shore Hardness]

The resin was cured by heat application at 100° C. for 30 minutes to form it into a board shape having a thickness of 8 mm. A test specimen of 30 mm width and 30 mm length was cut out of the above board-shaped form. The test specimen was used to measure the Shore hardness D with a desk-top durometer (Type D) according to JIS-K7215, using the calculation formula for the hardness based on the depth (h) of penetration of the indentor into the specimen when a specified load is placed on the indentor.

For the flexural modulus and Shore hardness of the conductive polymer, a test specimen for each property was produced by compacting polypyrrole powder obtained such as by chemical polymerization into the specified shape, and measured in the same manner as described above.

### Example 2

FIG. 2 is a schematic cross-sectional view showing a solid electrolytic capacitor of Example 2 according to the present invention.

In this example, a solid electrolytic capacitor was produced in the same manner as in Example 1, except that as shown in FIG. 2, a second resin layer 11 was formed to cover the entire surface of a first resin layer 10.

### Comparative Example 1

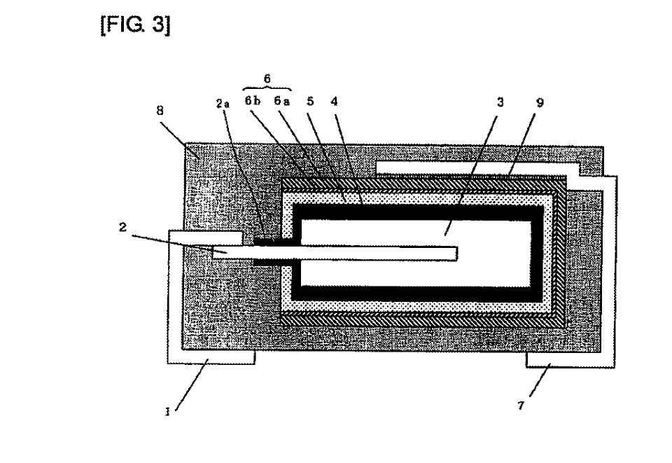

FIG. 3 is a schematic cross-sectional view showing a solid electrolytic capacitor of Comparative Example 1.

In this case, a solid electrolytic capacitor was produced in the same manner as in Example 1, except that neither first resin layer 10 nor second resin layer 11 were formed.

### Comparative Example 2

A solid electrolytic capacitor was produced in the same manner as in Example 1, except that in Example 1, Step 5 was not carried out and a first resin layer 10 was solely formed.

### Comparative Example 3

A solid electrolytic capacitor was produced in the same manner as in Example 1, except that in Example 1, Step 4 was not carried out and a second resin layer 11 was solely formed. The second resin layer 11 was formed so that it existed also in a region in which the first resin layer 10 was formed in FIG. 1.

### Comparative Example 4

A solid electrolytic capacitor was produced in the same manner as in Example 1, except that in Step 4 of Example 1, a first resin layer 10 was formed using an epoxy resin having a flexural modulus of 2000 MPa and a Shore hardness D of 70 and in Step 5 of Example 1, a second resin layer 11 was formed using an epoxy resin having a flexural modulus of 5000 MPa and a Shore hardness D of 90.

Note that the flexural modulus of each resin can be controlled by the amount of filler. If the amount of filler is increased, the flexural modulus can be increased, and if the amount of filler is decreased, the flexural modulus can be lowered.

### Comparative Example 5

A solid electrolytic capacitor was produced in the same manner as in Example 1, except that in Step 4 of Example 1, a first resin layer 10 was formed using a silicone resin having a flexural modulus of 1000 MPa and a Shore hardness D of 20 and in Step 5 of Example 1, a second resin layer 11 was formed using a silicone resin having a flexural modulus of 4000 MPa and a Shore hardness D of 50.

[Measurement of Leakage Current]

A voltage of 2.5 V was applied to each of the solid electrolytic capacitors produced in the above manners, and its leakage current was measured 20 seconds after the voltage application. The measurement results are shown in TABLE 1. Note that the values of leakage current are indicated in relative values when the value of leakage current in Example 2 is taken as 100.

TABLE 1

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 1 | 5000 | 90 | 1000 | 20 | 115 |
| Ex. 2 | 5000 | 90 | 1000 | 20 | 100 |
| Comp. | Not Exist | | Not Exist | | 1200 |
| Ex. 1 | | | | | |
| Comp. | 5000 | 90 | Not Exist | | 650 |
| Ex. 2 | | | | | |
| Comp. | Not Exist | | 1000 | 20 | 600 |
| Ex. 3 | | | | | |
| Comp. | 2000 | 70 | 5000 | 90 | 700 |
| Ex. 4 | | | | | |
| Comp. | 1000 | 20 | 4000 | 50 | 750 |
| Ex. 5 | | | | | |

As shown in TABLE 1, it can be seen that the solid electrolytic capacitors of Examples 1 and 2 according to the present invention significantly reduced the leakage current as compared to the solid electrolytic capacitors of Comparative Examples 1 to 5.

### Experiment 2

### Examples 3 to 8

Solid electrolytic capacitors were produced in the same manner as in Example 2, except that in Step 4 of Example 1, their respective first resin layers 10 were formed using respective epoxy resins having flexural moduli and Shore hardnesses D shown in TABLE 2.

### Comparative Examples 6 and 7

Solid electrolytic capacitors were produced in the same manner as in Example 2, except that in Step 4 of Example 1, their respective first resin layers 10 were formed using respective epoxy resins having flexural moduli and Shore hardnesses D shown in TABLE 2.

[Measurement of Leakage Current]

The leakage current of each of the solid electrolytic capacitor was measured in the same manner as in Experiment 1. The measurement results are shown in TABLE 2. Note that the values of leakage current shown in TABLE 2 are relative values when the value of leakage current in Example 2 is taken as 100.

TABLE 2

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 3 | 2000 | 88 | 1000 | 20 | 190 |
| Ex. 4 | 3000 | 90 | 1000 | 20 | 180 |
| Ex. 5 | 4000 | 88 | 1000 | 20 | 110 |
| Ex. 2 | 5000 | 90 | 1000 | 20 | 100 |
| Ex. 6 | 6000 | 92 | 1000 | 20 | 95 |
| Ex. 7 | 7000 | 92 | 1000 | 20 | 95 |
| Ex. 8 | 8000 | 93 | 1000 | 20 | 90 |
| Comp. | 800 | 83 | 1000 | 20 | 510 |
| Ex. 6 | | | | | |
| Comp. | 1000 | 85 | 1000 | 20 | 450 |
| Ex. 7 | | | | | |

As shown in TABLE 2, it can be seen that Examples 2 to 8 in which the first resin layer was formed using a resin having a greater flexural modulus than the second resin layer according to the present invention significantly reduced the leakage current as compared to Comparative Examples 6 and 7 in which the first resin layer was formed using a resin having a flexural modulus equal to or lower than the second resin layer.

### Experiment 3

### Examples 9 to 15

Solid electrolytic capacitors were produced in the same manner as in Example 2, except that in Step 5 of Example 1, their respective second resin layers 11 were formed using respective silicone resins having flexural moduli and Shore hardnesses D shown in TABLE 3.

Note that the flexural modulus of the silicone resin can be increased by increasing the content of spherical silica serving as a filler and can be lowered by decreasing the content of spherical silica serving as a filler.

### Comparative Examples 8 and 9

Solid electrolytic capacitors were produced in the same manner as in Example 2, except that in Step 5 of Example 1, their respective second resin layers 11 were formed using respective silicone resins having flexural moduli and Shore hardnesses D shown in TABLE 3.

<Measurement of Leakage Current>

The leakage current of each of the above solid electrolytic capacitors was measured in the same manner as in Experiment 1. The measurement results are shown in TABLE 3. Note that the values of leakage current shown in TABLE 3 are relative values when the value of leakage current in Example 2 is taken as 100.

TABLE 3

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 9 | 5000 | 90 | 700 | 20 | 90 |
| Ex. 10 | 5000 | 90 | 800 | 20 | 95 |
| Ex. 2 | 5000 | 90 | 1000 | 20 | 100 |
| Ex. 11 | 5000 | 90 | 2000 | 22 | 105 |
| Ex. 12 | 5000 | 90 | 2500 | 20 | 105 |
| Ex. 13 | 5000 | 90 | 3000 | 22 | 115 |
| Ex. 14 | 5000 | 90 | 3500 | 24 | 150 |
| Ex. 15 | 5000 | 90 | 4000 | 20 | 190 |
| Comp. | 5000 | 90 | 5000 | 25 | 560 |
| Ex. 8 | | | | | |
| Comp. | 5000 | 90 | 6000 | 25 | 760 |
| Ex. 9 | | | | | |

As shown in TABLE 3, it can be seen that the solid electrolytic capacitors of Examples 2 and 9 to 15 in which the second resin layer was formed using a resin having a smaller flexural modulus than the first resin layer according to the present invention significantly reduced the leakage current as compared to Comparative Examples 8 and 9 in which the second resin layer was formed from a resin having a flexural modulus equal to or greater than the first resin layer.

### Experiment 9

### Examples 16 to 19

Solid electrolytic capacitors were produced in the same manner as in Example 2, except that in Step 4 of Example 1, their respective first resin layers 10 were formed using respective epoxy resins having flexural moduli and Shore hardnesses D shown in TABLE 4 and in Step 5 of Example 1, their respective second resin layers 11 were formed using respective epoxy resins having flexural moduli and Shore hardnesses D shown in TABLE 4.

Note that for the first resin layer 10 and the second resin layer 11, their flexural modulus was changed by controlling the content of spherical silica serving as a filler in the composition of the epoxy resin used in Example 1. The Shore hardness D was changed by controlling the content of methyltetrahydrophthalic acid anhydride.

[Measurement of Leakage Current]

The leakage current of each of the above solid electrolytic capacitors was measured in the same manner as in Experiment 1. The measurement results are shown in TABLE 4. Note that the values of leakage current shown in TABLE 4 are relative values when the value of leakage current in Example 2 is taken as 100.

TABLE 4

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 16 | 8000 | 93 | 5000 | 80 | 190 |
| Ex. 17 | 8000 | 93 | 6000 | 82 | 280 |
| Ex. 18 | 8000 | 93 | 7000 | 82 | 290 |
| Ex. 19 | 8000 | 93 | 7500 | 85 | 295 |

As is evident from the results shown in TABLE 4, it can be seen that the leakage current can be further reduced by making the flexural modulus of the second resin layer smaller than the flexural modulus (6000 MPa) of the electrolyte layer.

### Experiment 5

### Examples 20 to 24

Solid electrolytic capacitors were produced in the same manner as in Example 2, except that in Step 4 of Example 1, their respective first resin layers 10 were formed from respective epoxy resins having flexural moduli and Shore hardnesses D shown in TABLE 5.

Note that the Shore hardness D was controlled by changing the content of methyltetrahydrophthalic acid anhydride contained in the epoxy resin. The Shore hardness D can be increased by increasing the content of methyltetrahydrophthalic acid anhydride and can be lowered by decreasing the content of methyltetrahydrophthalic acid anhydride.

[Measurement of Leakage Current]

The leakage current of each of the above solid electrolytic capacitors was measured in the same manner as in Experiment 1. The measurement results are shown in TABLE 5. Note that the values of leakage current are relative values when the value of leakage current in Example 2 is taken as 100.

TABLE 5

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 20 | 5000 | 50 | 1000 | 20 | 195 |
| Ex. 21 | 5000 | 60 | 1000 | 20 | 190 |
| Ex. 22 | 5000 | 70 | 1000 | 20 | 150 |
| Ex. 23 | 5000 | 80 | 1000 | 20 | 110 |
| Ex. 2 | 5000 | 90 | 1000 | 20 | 100 |
| Ex. 24 | 5000 | 95 | 1000 | 20 | 90 |

As is evident from the results shown in TABLE 5, it can be seen that the leakage current can be further reduced by allowing the Shore hardness of the resin forming the first resin layer 10 to be 80 or more and making it greater than that of the resin forming the second resin layer.

### Experiment 6

### Examples 25 to 31

Solid electrolytic capacitors were produced in the same manner as in Example 2, except that in Step 5 of Example 1, their respective second resin layers 11 were formed using respective silicone resins having flexural moduli and Shore hardnesses D shown in TABLE 6.

Note that the Shore hardness D of the silicone resin can be controlled by changing the content of organohydrogenpolysiloxane. The Shore hardness D can be increased by increasing the content of organohydrogenpolysiloxane and can be lowered by decreasing the content of organohydrogenpolysiloxane.

[Measurement of Leakage Current]

The leakage current of each of the above solid electrolytic capacitors was measured in the same manner as in Experiment 1. The measurement results are shown in TABLE 6. Note that the values of leakage current shown in TABLE 6 are relative values when the value of leakage current in Example 2 is taken as 100.

TABLE 6

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 25 | 5000 | 90 | 1000 | 10 | 90 |
| Ex. 26 | 5000 | 90 | 1000 | 15 | 90 |
| Ex. 2 | 5000 | 90 | 1000 | 20 | 100 |
| Ex. 27 | 5000 | 90 | 1000 | 30 | 105 |
| Ex. 28 | 5000 | 90 | 1000 | 40 | 105 |
| Ex. 29 | 5000 | 90 | 1000 | 50 | 115 |
| Ex. 30 | 5000 | 90 | 1000 | 60 | 150 |
| Ex. 31 | 5000 | 90 | 1000 | 65 | 155 |

As is evident from the results shown in TABLE 6, it can be seen that the leakage current can be further reduced by allowing the Shore hardness of the resin forming the second resin layer to be 50 or less and making it smaller than that of the resin forming the first resin layer.

### Experiment 7

### Examples 32 to 34

Solid electrolytic capacitors were produced in the same manner as in Example 2, except that in Step 4 of Example 1, their respective first resin layers 10 were formed using respective epoxy resins having flexural moduli and Shore hardnesses D shown in TABLE 7 and in Step 5 of Example 1, their respective second resin layers 11 were formed using respective epoxy resins having flexural moduli and Shore hardnesses D shown in TABLE 7.

[Measurement of Leakage Current]

The leakage current of each of the above solid electrolytic capacitors was measured in the same manner as in Experiment 1. The measurement results are shown in TABLE 7. Note that the values of leakage current shown in TABLE 7 are relative values when the value of leakage current in Example 2 is taken as 100.

TABLE 7

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 32 | 8000 | 93 | 5000 | 70 | 190 |
| Ex. 16 | 8000 | 93 | 5000 | 80 | 190 |
| Ex. 33 | 8000 | 93 | 5000 | 90 | 290 |
| Ex. 34 | 8000 | 93 | 5000 | 95 | 295 |

As is evident from the results shown in TABLES 6 and 7, it can be seen that the leakage current can be further reduced by making the Shore hardness D forming the second resin layer smaller than the Shore hardness D (90) of the electrolyte layer.

### Experiment 8

### Examples 35 to 37

Solid electrolytic capacitors were produced in the same manner as in Example 2, except that in Step 4 of Example 1, their respective first resin layers were formed using respective resins having flexural moduli and Shore hardnesses D shown in TABLE 8. Note that in Example 35, the first resin layer was formed using a silicone resin. In Example 36, the first resin layer was formed using a fluorine-contained resin (Trade Name “SIFEL3170-BK” manufactured by Shin-Etsu Chemical Co., Ltd.). In Example 37, the first resin layer was formed using a urethane resin (Trade Name “KU-7008” manufactured by Hitachi Chemical Co., Ltd.).

[Measurement of Leakage Current]

The leakage current of each of the above solid electrolytic capacitors was measured in the same manner as in Experiment 1. The measurement results are shown in TABLE 8. Note that the values of leakage current shown in TABLE 8 are relative values when the value of leakage current in Example 2 is taken as 100.

TABLE 8

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 2 | 5000 | 90 | 1000 | 20 | 100 |
| Ex. 35 | 3500 | 24 | 1000 | 20 | 290 |
| Ex. 36 | 1500 | 50 | 1000 | 20 | 280 |
| Ex. 37 | 2000 | 30 | 1000 | 20 | 285 |

As is evident from the results shown in TABLE 8, it can be seen that the first resin layer is preferably formed from an epoxy resin.

Note that although in the above examples a novolak type epoxy resin was used as a type of epoxy resin, epoxy resins of other types, such as naphthalene type or biphenyl type, can also be used similarly.

### Experiment 9

### Examples 38 to 40

Solid electrolytic capacitors were produced in the same manner as in Example 2, except that in Step 5 of Example 1, their respective second resin layers 11 were formed using respective resins having flexural moduli and Shore hardnesses D shown in TABLE 9.

Note that in Example 38, the second resin layer was formed using the same urethane resin as in Example 37. In Example 39, the second resin layer was formed using the fluorine-contained resin used in Example 36. In Example 40, the second resin layer was formed using the epoxy resin used to form the first resin layer in Example 5.

[Measurement of Leakage Current]

The leakage current of each of the above solid electrolytic capacitors was measured in the same manner as in Experiment 1. The measurement results are shown in TABLE 9. Note that the values of leakage current shown in TABLE 9 are relative values when the value of leakage current in Example 2 is taken as 100.

TABLE 9

| | First Resin Layer | | Second Resin Layer | | Leakage |
|---|---|---|---|---|---|
| | Flexural | Shore | Flexural | Shore | Current |
| | Modulus | Hardness | Modulus | Hardness | (Relative |
| | (MPa) | D | (MPa) | D | Value) |
| Ex. 2 | 5000 | 90 | 1000 | 20 | 100 |
| Ex. 38 | 5000 | 90 | 2000 | 30 | 120 |
| Ex. 39 | 5000 | 90 | 1500 | 50 | 250 |
| Ex. 40 | 5000 | 90 | 4000 | 88 | 285 |

As is evident from the results shown in TABLE 9, it can be seen that the second resin layer is preferably formed using a silicone resin or an urethane resin.

1. A solid electrolytic capacitor comprising:
an anode made of a valve metal or an alloy thereof;
an anode lead partly embedded in the anode;
a dielectric layer provided on the surface of the anode;
an electrolyte layer provided on the surface of the dielectric layer,
a cathode layer provided on a part of the electrolyte layer lying on the external surface of the anode; and
a resin outer package formed to cover a capacitor element comprising the anode in which a part of the anode lead is embedded, the dielectric layer, the electrolyte layer and the cathode layer,
wherein the solid electrolytic capacitor includes: a first resin layer provided to cover the root of an extension of the anode lead extended from the anode, in which the anode lead is embedded, and cover parts of the dielectric layer and the electrolyte layer located on a neighboring part of the extension; and a second resin layer provided to cover the first resin layer, and the second resin layer is formed from a resin having a smaller flexural modulus than a resin forming the first resin layer.

2. The solid electrolytic capacitor according to claim 1, wherein the second resin layer is provided to cover the entire surface of the first resin layer.

3. The solid electrolytic capacitor according to claim 1, wherein the flexural modulus of the resin forming the second resin layer is smaller than that of a material forming the electrolyte layer covered by the second resin layer.

4. The solid electrolytic capacitor according to claim 1, wherein the Shore hardness of the resin forming the second resin layer is smaller than that of the material forming the electrolyte layer covered by the second resin layer.

5. The solid electrolytic capacitor according to claim 1, wherein the Shore hardness of the resin forming the first resin layer is not less than 80 and is greater than that of the resin forming the second resin layer.

6. The solid electrolytic capacitor according to claim 1 wherein the Shore hardness of the resin forming the second resin layer is not more than 50 and is smaller than that of the resin forming the first resin layer.

7. The solid electrolytic capacitor according to claim 1, wherein the first resin layer is formed from an epoxy resin.

8. The solid electrolytic capacitor according to claim 1, wherein the second resin layer is formed from a silicone resin or an urethane resin.

9. The solid electrolytic capacitor according to claim 1, wherein the electrolyte layer is formed from a conductive polymer.

10. A method for manufacturing the solid electrolytic capacitor according to claim 1, the method comprising the steps of:
forming the anode in which a part of the anode lead is embedded;
forming the dielectric layer on the surface of the anode;
forming the electrolyte layer on the surface of the dielectric layer,
forming the cathode layer on the electrolyte layer,
forming the first resin layer by application to cover parts of the dielectric layer and the electrolyte layer located at the root of the extension of the anode lead extended from the anode in which the anode lead is embedded and on the neighboring part of the extension;
forming the second resin layer by application to cover the first resin layer, and
forming the resin outer package to cover the capacitor element.
